(19) United States
(12) Patent Application Publication
(10) Pub. No.: US 2022/0165011 A1
(43) Pub. Date: May 26, 2022

(54) METHOD FOR REARRANGING CARTOON CONTENT

(71) Applicants: NAVER WEBTOON LTD., Seongnam-si (KR); R&B FOUNDATION SUNGKYUNKWAN UNIVERSITY, Suwon-si (KR)

(72) Inventors: Jae Hyuk CHANG, Seongnam-si (KR); Chan Kyu PARK, Seongnam-si (KR); Sung Kil LEE, Suwon-si (KR); Soon Hyeon KWON, Suwon-si (KR); So Young PARK, Yongin-si (KR)

(21) Appl. No.: 17/650,141

(22) Filed: Feb. 7, 2022

Related U.S. Application Data
(63) Continuation of application No. PCT/KR2020/010503, filed on Aug. 7, 2020.

(30) Foreign Application Priority Data
Aug. 7, 2019 (KR) 10-2019-0096330

(51) Int. Cl. G06T 11/60; G06F 3/04845

(52) U.S. Cl. CPC G06T 11/60; G06F 3/04845

(57) ABSTRACT

A method for rearranging image cuts of cartoon content is performed by a computing device and includes the steps of loading first content in which a plurality of image cuts are arrayed two-dimensionally; extracting a plurality of cut areas, in which the plurality of image cuts from the first content are positioned, respectively; determining the arrayed order of the plurality of image cuts; and generating second content by rearranging the plurality of cut areas according to the arrayed order.

### CROSS-REFERENCE TO RELATED APPLICATIONS

This is a continuation application of International Application No. PCT/KR2020/010503, filed Aug. 7, 2020, which claims the benefit of Korean Patent Application No. 10-2019-0096330, filed Aug. 7, 2019.

### BACKGROUND OF THE INVENTION

### Field of Invention

The present disclosure relates to a method of rearranging image cuts of cartoon content. More specifically, the present disclosure relates to a method of changing the arrangement of image cuts from content having a published cartoon format to content having a webtoon format.

### Description of Related Art

In the past, cartoon was published as magazines or books, but is recently disclosed as webtoon which can be viewed through the Internet. In publishing cartoon, a plurality of image cuts is disposed in a page having a determined ratio. However, a page of webtoon may have a long length because the ratio of a page is not limited. For this reason, in publishing cartoon, a plurality of image cuts is arranged in a two-dimensional manner (i.e., in two directions) in one page. In contrast, in a webtoon, a plurality of image cuts is longitudinally lengthily arranged in one direction.

Recently, writers of published cartoons have also been making existing published cartoons available online by converting published cartoons into webtoons. However, a lot of time and effort are necessary to convert published cartoons into webtoons.

### BRIEF SUMMARY OF THE INVENTION

An object of the present disclosure is to provide a method capable of reducing time and effort consumed to convert published cartoons into webtoons.

Another object of the present disclosure is to provide an interface for extracting elements of published cartoon along with layers of webtoon, respectively, and rearranging image cuts of the published cartoon as webtoon.

As technical means for achieving the aforementioned technical objects, according to a first aspect of the present disclosure, a method of rearranging cartoon content, which is performed by a computing device, includes loading first content in which a plurality of image cuts is arranged in a two-dimensional manner, extracting, from the first content, a plurality of cut areas in which the plurality of image cuts is located, respectively, determining an arrangement order of the plurality of image cuts, and generating second content by rearranging the plurality of cut areas in the arrangement order.

According to an example, the second content may include the plurality of image cuts arranged in a row in the arrangement order.

According to another example, the method of rearranging cartoon content may further include receiving a first mode input for selecting a cut area, receiving a first selection input for selecting a blank area in which the plurality of image cuts is not located in the first content, receiving an extraction instruction for extracting the plurality of cut areas, and extracting the blank area based on the first selection input and extracting, from the first content, the plurality of cut areas except the blank area, in response to the extraction instruction.

According to another example, the first content may include at least one of a speech bubble including text, a sound effect expressed in text, and text that is not included a speech bubble.

According to another example, in determining the arrangement order, the arrangement order may be automatically determined based on a left binding mode or a right binding mode selected based on a user's input.

According to another example, in determining the arrangement order, the arrangement order may be manually determined based on a user's input. When the plurality of cut areas is rearranged, at least two image cuts to which the arrangement order is identically designated among the plurality of image cuts may be integrated and rearranged.

According to a second aspect of the present disclosure, there is provided a computer program stored in a medium in order to execute the method of rearranging cartoon content in combination with hardware.

According to various embodiments of the present disclosure, a writer of published cartoons can reduce time and effort consumed to convert content of published cartoons into webtoon content by using the method of rearranging cartoon content according to the present disclosure.

According to various embodiments of the present disclosure, a user can easily extract each of elements of content of published cartoon. An arrangement order can be automatically assigned to image cuts extracted by a user. Image cuts can be automatically longitudinally arranged.

Furthermore, a user can easily perform a task for editing image cuts or changing the contents of text because various functions are provided.

### BRIEF DESCRIPTION OF THE DRAWINGS

FIG. 1 illustrates the components of an electronic device which executes a method of rearranging cartoon content according to an embodiment of the present disclosure.

FIG. 2 illustrates an example of first content according to an embodiment of the present disclosure.

FIG. 3 illustrates an example of second content according to an embodiment of the present disclosure.

FIG. 4 illustrates the internal components of a processor of the electronic device according to an embodiment of the present disclosure.

FIG. 5 illustrates a flowchart of a method of rearranging cartoon content according to an embodiment of the present disclosure.

FIG. 6 illustrates an example of a cartoon content rearrangement tool according to an embodiment of the present disclosure.

FIG. 7 is an exemplary diagram for describing a method of selecting a cut area by using the cartoon content rearrangement tool according to an embodiment of the present disclosure.

FIG. 8 is an exemplary diagram for describing a method of selecting a speech bubble area by using the cartoon content rearrangement tool according to an embodiment of the present disclosure.

FIG. 9 is an exemplary diagram for describing a method of selecting a sound effect area by using the cartoon content rearrangement tool according to an embodiment of the present disclosure.

FIG. 10 is an exemplary diagram for describing a method of selecting a text area by using the cartoon content rearrangement tool according to an embodiment of the present disclosure.

FIG. 11 exemplarily illustrates areas selected by using the cartoon content rearrangement tool according to an embodiment of the present disclosure.

FIG. 12 exemplarily illustrates a screen in a case where a rearrangement button is selected by using the cartoon content rearrangement tool according to an embodiment of the present disclosure.

### DETAILED DESCRIPTION OF THE INVENTION

Various embodiments are described hereinafter in detail with reference to the accompanying drawings in order for a person having ordinary knowledge in the art to which the present disclosure pertains to easily carry out the present disclosure. However, the subject matter of the present disclosure may be modified and implemented in various forms, and is not limited to embodiments described in this specification. In describing embodiments disclosed in this specification, a detailed description of a related known technology will be omitted if it is deemed to make the subject matter of the present disclosure unnecessarily vague. The same or similar component is assigned the same reference numeral, and a redundant description thereof is omitted.

In the entire specification, when it is described that one element is “connected to” the other element, the one element may be “directly connected” to the other element or may also be “indirectly connected” to the other element through a third element therebetween. Furthermore, when it is said that one element “includes” the other element, this means that the one element may further include another element not the exclusion of another element unless explicitly described to the contrary.

Some embodiments may be described as functional block components and various processing steps. Some or all of such function blocks may be implemented as various numbers of hardware and/or software components executing a specific function. For example, function blocks of the present disclosure may be implemented by one or more microprocessors or may be implemented by circuit components for a given function. Function blocks of the present disclosure may be implemented in various programming or scripting languages. Function blocks of the present disclosure may be implemented as an algorithm executed in one or more processors. A function performed by a function block of the present disclosure may be performed by a plurality of function blocks or functions performed by a plurality of function blocks in the present disclosure may be performed by one function block. Furthermore, the present disclosure may adopt a conventional technology for electronic environment setting, signal processing and/or data processing.

In the present disclosure, “first content” may denote an image file of a page of cartoon published as a book, which has been electronically stored. For example, first content may be a scan file or image file obtained by scanning a page of a published cartoon. In general, in the first content, a plurality of image cuts is arranged in a two-dimensional manner (two directions) in one page. For example, a plurality of image cuts may be arranged as a plurality of rows, and one or more image cuts may be transversely arranged in each row. In published cartoons, there is a case where one image cut or a part of one image cut occupies one page. Even in this case, the first content may be converted into second content having a webtoon format according to a method of the present disclosure.

In the present disclosure, “second content” may denote an image file having a webtoon format. An image file having the webtoon format may include a common image file, a CAD file or a photoshop file (PSD). In general, in second content having the webtoon format, a plurality of image cuts is arranged in a single row or a column (e.g., longitudinally or transversely) so that a user can easily use the image cuts online. Second content may include a plurality of layers, such as a drawing layer, a speech bubble layer, and a text layer, for example.

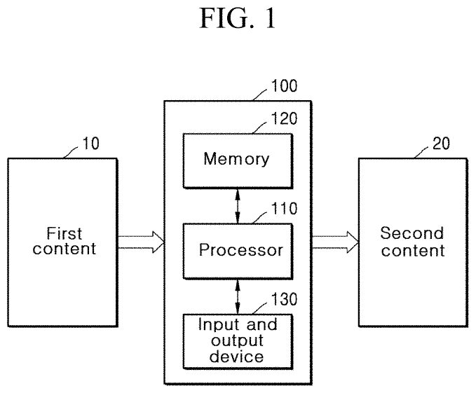

FIG. 1 illustrates components of an electronic device which executes a method of rearranging cartoon content according to an embodiment of the present disclosure.

Referring to FIG. 1, an electronic device 100 may include a processor 110, a memory 120, and an input and output device 130.

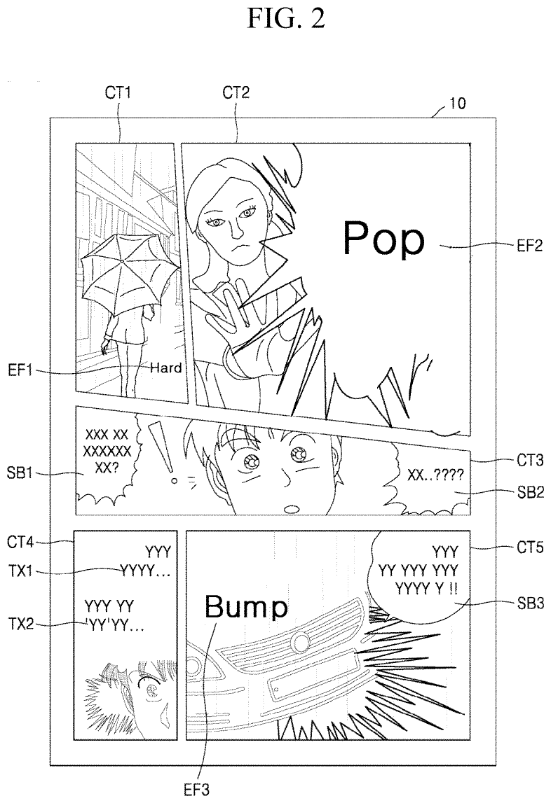

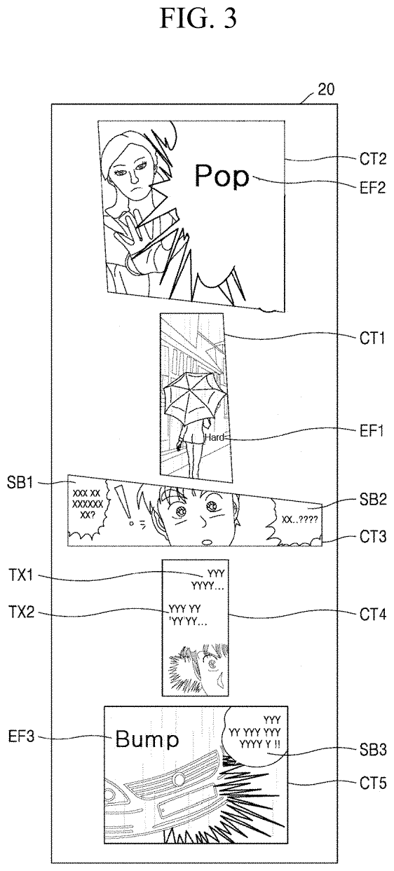

A program code for executing a method of rearranging cartoon content according to an embodiment of the present disclosure may be installed in the electronic device 100. If such a program code is installed in the electronic device 100, the electronic device 100 may load first content 10, and may generate second content 20 in which image cuts of the first content 10 have been rearranged. The electronic device 100 may be a PC, a notebook PC, a tablet PC, a smart TV, a smartphone, and other mobile or non-mobile computing devices, but the disclosure is not limited thereto. The first content 10 and the second content 20 are more specifically described below with reference to FIGS. 2 and 3.

The processor 110 may be configured to process an instruction of a computer program by performing basic arithmetic, logic, and input and output operations. The instruction may be provided to the processor 110 by the memory 120 or a communication module. For example, the processor 110 may be configured to execute a received instruction based on a program code stored in a recording device, such as the memory 120.

The memory 120 is a recording medium readable by the processor 110 of the electronic device 100, and may include permanent mass storage devices, such as a random access memory (RAM), a read only memory (ROM) and a disk drive. In this case, the permanent mass storage device, such as a ROM and a disk drive, may be included in the electronic device 100 as a separate permanent storage device different from the memory 120. Furthermore, an operating system and at least one program code may be stored in the memory 120. For example, a program code for executing a method of rearranging cartoon content according to various embodiments of the present disclosure may be stored in the memory 120. Furthermore, a program code for editing an image may be stored in the memory 120. Software for executing a method of rearranging cartoon content according to various embodiments of the present disclosure may be a plug-in application added on in order to improve the function of an image edit program (e.g., a photoshop program).

According to various embodiments, such software components may be loaded from a computer-readable recording medium different from the memory 120 by using a drive mechanism. Such a separate computer-readable recording medium may include computer-readable recording media, such as a floppy drive, a disk, a tape, a DVD/CD-ROM drive, and a memory card. According to other various embodiments, software components may be loaded onto the memory 120 through a communication module and not necessarily from a computer-readable recording medium.

The input and output device 130 may include an input device which receives an input from a user and delivers the input to the processor 110 and an output device which outputs, to a user, information provided by the processor 110. For example, the input device may include a keyboard, a mouse, etc. The input device may include a touch screen, a microphone, a button, etc. depending on the type of electronic device 100. The output device may include an image display device such as a display, a voice output device such as a speaker or an earphone, etc.

According to other embodiments, the electronic device 100 may include more components than the components illustrated in FIG. 2. For example, the electronic device 100 may further include a communication module which accesses a network and enables data to be transmitted to and received from another electronic device (e.g., a server or another computing device). The electronic device 100 may be connected to a scanner device through the communication module, and may receive a scanned file of any one page of a published cartoon. Furthermore, the electronic device 100 may further include components, such as a transceiver, a global positioning system (GPS) module, a camera, various sensors, and a database.

FIG. 2 illustrates an example of first content according to an embodiment of the present disclosure.

Referring to FIG. 2, first content 10 is an image file of one page of cartoon published as a book, which has been electronically stored, and includes a plurality of image cuts CT1 to CT5. The plurality of image cuts CT1 to CT5 may be arranged in a two-dimensional manner as illustrated in FIG. 2. For example, first and second image cuts CT1 and CT2 may be disposed in a first row, a third image cut CT3 may be disposed in a second row, and fourth and fifth image cuts CT4 and CT5 may be disposed in a third row. The arrangement of the image cuts CT1 to CT5 illustrated in FIG. 2 is only illustrative, and an arrangement different from the arrangement is also possible. In FIG. 2, the first content 10 includes the five image cuts CT1 to CT5, but this is also illustrative. Image cuts less than or greater than the five image cuts may be included in the first content 10.

The first content 10 is cartoon content, and the image cuts CT1 to CT5 may include cartoon drawings as illustrated in FIG. 2. Furthermore, the first content 10 may include at least one of speech bubbles SB1 to SB3 containing text, sound effects EF1 to EF3 expressed in text, and text TX1 and TX2 not contained in a speech bubble. The speech bubbles SB1 to SB3 containing text, the sound effects EF1 to EF3 expressed in text, and the text TX1 and TX2 not contained in a speech bubble are simply denoted as the speech bubbles SB1 to SB3, the sound effects EF1 to EF3, and the text TX1 and TX2, respectively.

At least one of the image cuts CT1 to CT5 may include one or more speech bubbles SB1 to SB3. FIG. 2 exemplarily illustrates that the third image cut CT3 includes first and second speech bubbles SB1 and SB2 and the fifth image cut CT5 includes a third speech bubble SB3. The speech bubbles SB1 to SB3 may include text located therein.

At least one of the image cuts CT1 to CT5 may include the sound effects EF1 to EF3 represented by overlapping a cartoon drawing. FIG. 2 exemplarily illustrates that the first image cut CT1 includes the first sound effect EF1, the second image cut CT2 includes the second sound effect EF2, and the fifth image cut CT5 includes the third sound effect EF3. The sound effects EF1 to EF3 are representations of a background sound or a site sound in text as cartoon schemes. For example, the sound effects EF1 to EF3 may include “Hard” for animatedly representing the state in which it is raining, “Pop” for animatedly highlighting and representing a hit or explosion situation, “Bump” for animatedly highlighting and representing a collision situation, etc.

At least one of the image cuts CT1 to CT5 may include the text TX1 and TX2. In general, in cartoon, a line or thought of a character is represented as a speech bubble containing text. A description of a background or situation is represented as text that is not contained in a speech bubble. There is a case where a thought of a character is represented as text that is not contained in a speech bubble. As described above, the first content 10 may include the text TX1 and TX2 not contained in a speech bubble. FIG. 2 exemplarily illustrates that the fourth image cut CT4 includes the first and second text TX1 and TX2.

The speech bubbles SB1 to SB3, the sound effects EF1 to EF3, and the text TX1 and TX2 basically include letters having a meaning. The letters needs to be separated from a cartoon drawing because the letters may be translated in accordance with a corresponding country. The first content 10 has no layer that distinguishes between elements because the first content is an image file obtained by scanning or photographing one page of a cartoon book without any change. According to the method of the present disclosure, a user can easily separate elements of the first content 10, for example, the image cuts CT1 to CT5, the speech bubbles SB1 to SB3, the sound effects EF1 to EF3, and the text TX1 and TX2.

A method of reading and writing letters is different for each country. Accordingly, a direction in which pages of a book are bound may be different. For example, in Korea, a left binding method of binding pages of a book on the left side is used. In contrast, in Japan, a right binding method of binding pages of a book on the right side is chiefly used. For example, if the first content 10 produced in a country in which the right binding method is used is to be converted into second content 20 suitable for a country in which the left binding method is used, the actual order of the image cuts CT1 to CT5 may be different. For example, the second image cut CT2 may be located ahead of the first image cut CT1 in terms of the sequence of the cartoon. Furthermore, if two speech bubbles are present in one image cut, it may be natural that locations of the two speech bubbles are reversed in terms of the sequence of the cartoon. According to a method of the present disclosure, the first content 10 can be easily converted into the second content 20 having a webtoon format because an arrangement order of the image cuts CT1 to CT5 can be automatically determined or easily manually set. Furthermore, locations of speech bubbles can be easily changed because elements of the first content 10 can be easily separated from each other.

FIG. 3 illustrates an example of second content according to an embodiment of the present disclosure.

FIG. 3 exemplarily illustrates second content 20 generated according to a method of the present disclosure. As exemplarily illustrated in FIG. 3, in the second content 20, the second image cut CT2, the first image cut CT1, the third image cut CT3, the fourth image cut CT4, and the fifth image cut CT5 are arranged in a single column. Such an arrangement order is only illustrative. In FIG. 3, the image cuts CT1 to CT5 are longitudinally disposed, but may be transversely arranged.

Even in the second content 20, as in the first content 10, the second image cut CT2 includes the second sound effect EF2. The first image cut CT1 includes the first sound effect EF1. The third image cut CT3 includes the first and second speech bubbles SB1 and SB2. The fourth image cut CT4 includes the first and second text TX1 and TX2. The fifth image cut CT5 includes the third sound effect EF3 and the third speech bubble SB3 .

According to a method of the present disclosure, the image cuts CT1 to CT5 of the first content 10 may be easily arranged as second content 20.

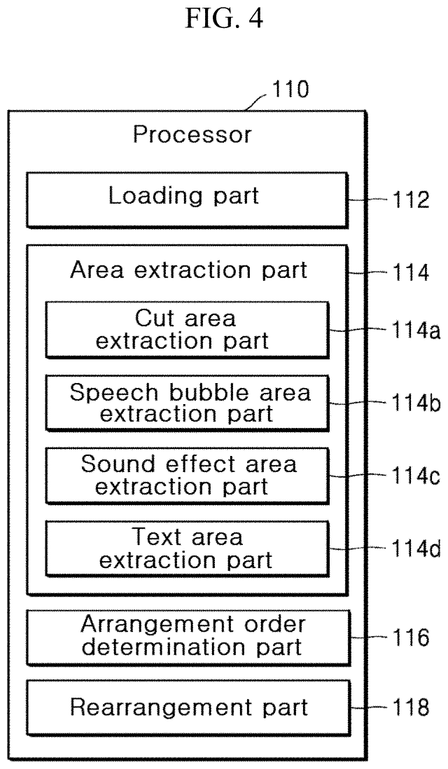

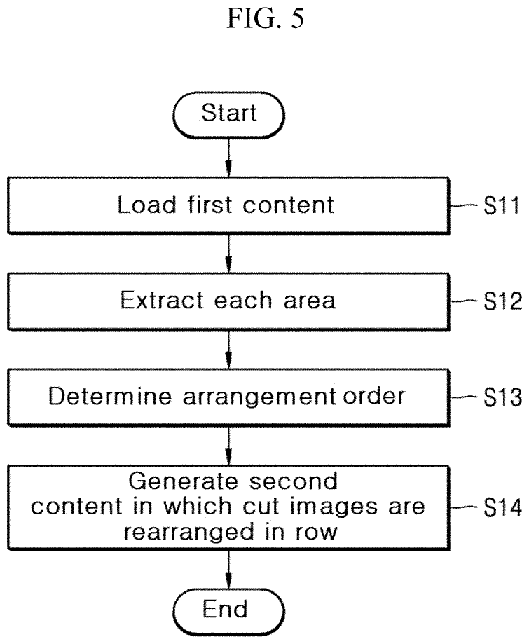

FIG. 4 illustrates internal components of a processor of the electronic device according to an embodiment of the present disclosure. FIG. 5 illustrates a flowchart of a method of rearranging cartoon content according to an embodiment of the present disclosure.

Referring to FIGS. 4 and 5, a processor 110 includes a loading part 112, an area extraction part 114, an arrangement order determination part 116, and a rearrangement part 118. The function parts 112, 114, 116, and 118 may be function blocks executed by the processor 110. A program code that is necessary for the processor 110 to perform operations of the function parts 112, 114, 116, and 118 may be stored in the memory 120.

The area extraction part 114 includes a cut area extraction part 114a for extracting the image cuts CT1 to CT5 of the first content 10, a speech bubble area extraction part 114b for extracting the speech bubbles SB1 to SB3 of the first content 10, a sound effect area extraction part 114c for extracting the sound effects EF1 to EF3 of the first content 10, and a text area extraction part 114d for extracting the text TX1 and TX2 of the first content 10.

The loading part 112 may load the first content 10 (S11). The first content 10 may include a plurality of image cuts CT1 to CT5 arranged in a two-dimensional manner as illustrated in FIG. 2. The first content 10 may include the speech bubbles SB1 to SB3, the sound effects EF1 to EF3, and the text TX1 and TX2.

The area extraction part 114 may extract a plurality of cut areas CT1 to CT5 in which the plurality of image cuts CT1 to CT5 is located, respectively, from the first content 10 (S12). The cut areas CT1 to CT5 denote areas in which the image cuts CT1 to CT5 are located, respectively, in the first content 10, and are assigned the same reference numerals as the image cuts CT1 to CT5. According to an example, the cut area extraction part 114a may extract the plurality of cut areas CT1 to CT5 from the first content 10.

According to an embodiment, the cut area extraction part 114a may receive, from a user, a first mode input for extracting a cut area. The cut area extraction part 114a may receive a first selection input for selecting a blank area in which the image cuts CT1 to CT5 are not located in the first content 10. The cut area extraction part 114a may receive an extraction instruction for extracting the cut areas CT1 to CT5. The cut area extraction part 114a may extract the cut areas CT1 to CT5 by extracting a blank area based on the first selection input in response to an extraction instruction and excluding the blank area from the first content 10. If the blank area is excluded from the entire area of the first content 10, only the cut areas CT1 to CT5 remain. Since the image cuts CT1 to CT5 are separated from each other as illustrated in FIG. 2, the cut area extraction part 114a may separate the cut areas CT1 to CT5 from an area except the blank area in the entire area of the first content 10.

The area extraction part 114 may provide a user interface which enables a user to input a first mode for extracting a cut area. Furthermore, the area extraction part 114 may provide a user interface which enables a user to select a blank area. The area extraction part 114 may provide a user interface which enables a user to select a blank area by using a selection tool of an image edit program. For example, when a user selects any one location of a blank area by using a selection tool of a photoshop program, in particular, a magic wand, the entire blank area may be selected.

The arrangement order determination part 116 may determine an arrangement order of the plurality of image cuts CT1 to CT5 extracted by the area extraction part 114 (S13).

According to an embodiment, the arrangement order determination part 116 may automatically determine an arrangement order of the plurality of image cuts CT1 to CT5. To this end, the arrangement order determination part 116 may receive, from a user, information about whether the first content 10 has the left binding method or the right binding method. The arrangement order determination part 116 may automatically determine an arrangement order of the image cuts CT1 to CT5 based on a left binding mode (i.e., from left to right) or right binding mode (i.e., from right to left) selected based on a user's input.

According to an embodiment, the arrangement order determination part 116 may manually determine an arrangement order of the plurality of image cuts CT1 to CT5 based on a user's input. The arrangement order determination part 116 may provide a user interface which enables a user to adjust an arrangement order of the plurality of image cuts CT1 to CT5. A user may adjust an arrangement order of each of the plurality of image cuts CT1 to CT5 by using the user interface provided by the arrangement order determination part 116.

According to an example, a user may designate the same arrangement order to at least two of the plurality of image cuts CT1 to CT5 through the user interface. In this case, the at least two image cuts to which the same arrangement order has been designated may be bound, integrated and be disposed in the second content 20 as a single cut or image.

The rearrangement part 118 may generate the second content 20 in which the cut areas CT1 to CT5 have been rearranged in a column by rearranging the plurality of cut areas CT1 to CT5 previously arranged in rows in the first content 10 based on an arrangement order determined by the arrangement order determination part 116 (S14), as exemplarily illustrated in FIG. 3.

According to an embodiment, the rearrangement part 118 may receive, from a user, a rearrangement mode input about a rearrangement mode. The rearrangement part 118 may provide a user interface which enables a user to input a rearrangement mode.

According to an example, the rearrangement mode may include a simple alignment mode in which the image cuts CT1 to CT5 are arranged in a column based on center alignment without changing the sizes of the image cuts CT1 to CT5. According to an example, the rearrangement mode may include a width alignment mode in which the widths of the image cuts CT1 to CT5 are changed identically with a document width of the second content 20. According to an example, the rearrangement part 118 may provide a user interface which enables a user to set a document width of the second content 20.

The rearrangement part 118 may rearrange the plurality of cut areas CT1 to CT5 based on a rearrangement mode input by a user. In the case of the simple alignment mode, as illustrated in FIG. 3, the image cuts CT1 to CT5 may be arranged in a column without a change in the sizes thereof. In the case of the width alignment mode, the image cuts CT1 to CT5 may be enlarged or reduced identically with a document width of the second content 20.

The speech bubble area extraction part 114b may extract, from the first content 10, a plurality of speech bubble areas SB1 to SB3 in which the plurality of speech bubbles SB1 to SB3 is located, respectively. The speech bubble areas SB1 to SB3 denote areas in which the speech bubbles SB1 to SB3 are located, respectively, in the first content 10, and are assigned the same reference numerals as the speech bubbles SB1 to SB3. The speech bubble areas SB1 to SB3 may be spaced apart from one another.

According to an embodiment, the speech bubble area extraction part 114b may receive, from a user, a second mode input for extracting a speech bubble area. The speech bubble area extraction part 114b may receive a plurality of second selection inputs for selecting the plurality of speech bubble areas SB1 to SB3, respectively, from the first content 10. The speech bubble area extraction part 114b may receive an extraction instruction for extracting the speech bubble areas SB1 to SB3. The speech bubble area extraction part 114b may extract the plurality of speech bubble areas SB1 to SB3 based on the second selection inputs in response to the extraction instruction.

The area extraction part 114 may provide a user interface which enables a user to input a second mode for extracting a speech bubble area. Furthermore, the area extraction part 114 may provide a user interface which enables a user to select speech bubble areas. The area extraction part 114 may provide a user interface which enables a user to select speech bubble areas by using a selection tool of an image edit program. For example, when a user selects any one location within a speech bubble area by using a selection tool of a photoshop program, in particular, a magic wand, the corresponding speech bubble area may be selected. The speech bubble area can be accurately selected by using the setting of a border width of the magic wand.

According to an example, an extraction instruction for extracting the speech bubble areas SB1 to SB3 may be the same as an extraction instruction for extracting the plurality of cut areas CT1 to CT5. In this case, in response to one extraction instruction, the speech bubble areas SB1 to SB3 and the cut areas CT1 to CT5 may be extracted together.

The rearrangement part 118 may associate the extracted speech bubble areas SB1 to SB3 with the extracted cut areas CT1 to CT5. For example, in FIG. 2, the rearrangement part 118 may associate the first and second speech bubble areas SB1 and SB2 with the third cut area CT3, and may associate the third speech bubble area SB3 with the fifth cut area CT5. Accordingly, when the rearrangement part 118 rearranges the cut areas CT1 to CT5, the speech bubble areas SB1 to SB3 may also be arranged along with the cut areas CT1 to CT5.

The sound effect area extraction part 114c may extract, from the first content 10, a plurality of sound effect areas EF1 to EF3 in which the plurality of sound effects EF1 to EF3 is located, respectively. The sound effect areas EF1 to EF3 denote areas in which the sound effects EF1 to EF3 are located, respectively, in the first content 10, and are assigned the same reference numerals as the sound effects EF1 to EF3.

According to an embodiment, the sound effect area extraction part 114c may receive, from a user, a third mode input for extracting a sound effect area. The sound effect area extraction part 114c may receive a plurality of third selection inputs for selecting the plurality of sound effect areas EF1 to EF3, respectively, from the first content 10. The sound effect area extraction part 114c may receive an extraction instruction for extracting the sound effect areas EF1 to EF3. The sound effect area extraction part 114c may extract the plurality of sound effect areas EF1 to EF3 based on the third selection inputs in response to the extraction instruction.

The area extraction part 114 may provide a user interface which enables a user to input a third mode for extracting a sound effect area. Furthermore, the area extraction part 114 may provide a user interface which enables a user to select sound effect areas. The area extraction part 114 may provide a user interface which enables a user to select sound effect areas by using a selection tool of an image edit program. For example, when a user selects any one location within a sound effect area by using a selection tool of a photoshop program, in particular, a magic wand, the corresponding sound effect area may be selected. The sound effect area can be accurately selected by using the setting of a border width of the magic wand.

According to an example, an extraction instruction for extracting the sound effect areas EF1 to EF3 may be the same as an extraction instruction for extracting the plurality of cut areas CT1 to CTS. In this case, in response to one extraction instruction, the sound effect areas EF1 to EF3 and the cut areas CT1 to CT5 may be extracted together.

The rearrangement part 118 may associate the extracted sound effect areas EF1 to EF3 with the extracted cut areas CT1 to CT5. For example, in FIG. 2, the rearrangement part 118 may associate the first sound effect area EF1 with the first cut area CT1, may associate the second sound effect area EF2 with the second cut area CT2, and may associate the third sound effect area EF3 with the fifth cut area CT5. Accordingly, when the rearrangement part 118 rearranges the cut areas CT1 to CT5, the sound effect areas EF1 to EF3 may also be arranged along with the cut areas CT1 to CT5. According to an example, a specific sound effect area may be disposed in two cut areas. In this case, when rearranging cut areas, the rearrangement part 118 may integrate and arrange two cut areas along with a specific sound effect area so that the two cut areas are matched with an intention of a writer who has drawn the first content 10.

The text area extraction part 114d may extract, from the first content 10, a plurality of text areas TX1 and TX2 in which a plurality of pieces of text TX1 and TX2 that is not contained in a speech bubble is located, respectively. The text areas TX1 and TX2 denote areas in which the text TX1 and TX2 is located, respectively, in the first content 10, and are assigned the same reference numerals as the text TX1 and TX2.

According to an embodiment, the text area extraction part 114d may receive, from a user, a fourth mode input for extracting a text area. The text area extraction part 114d may receive a plurality of fourth selection inputs for selecting the plurality of text areas TX1 and TX2, respectively, from the first content 10. The text area extraction part 114d may receive an extraction instruction for extracting the text areas TX1 and TX2. The text area extraction part 114d may extract the plurality of text areas TX1 and TX2 based on the fourth selection inputs in response to the extraction instruction.

The area extraction part 114 may provide a user interface which enables a user to input a fourth mode for extracting a text area. Furthermore, the area extraction part 114 may provide a user interface which enables a user to select text areas. The area extraction part 114 may provide a user interface which enables a user to select text areas by using a selection tool of an image edit program. For example, when a user designates a text area including text by using a selection tool of a photoshop program, in particular, a rectangular selection tool, the corresponding text area may be selected.

According to an example, an extraction instruction for extracting the text areas TX1 and TX2 may be the same as an extraction instruction for extracting the plurality of cut areas CT1 to CT5. In this case, in response to one extraction instruction, the text areas TX1 and TX2 and the cut areas CT1 to CT5 may be extracted together.

The rearrangement part 118 may associate the extracted text areas TX1 and TX2 with the extracted cut areas CT1 to CT5. For example, in FIG. 2, the rearrangement part 118 may associate the first and second text areas TX1 and TX2 with the fourth cut area CT4. Accordingly, when the rearrangement part 118 rearranges the cut areas CT1 to CT5, the text areas TX1 and TX2 may also be arranged along with the cut areas CT1 to CT5.

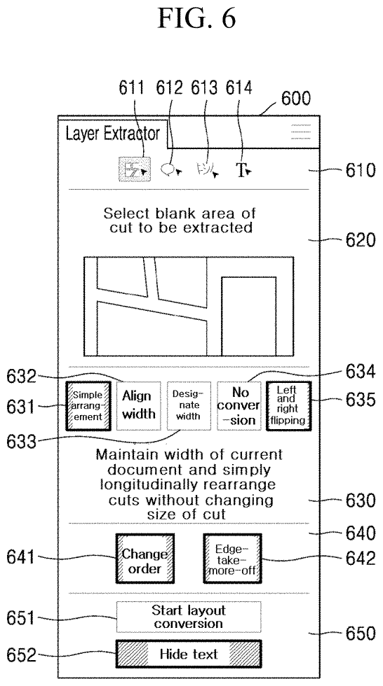

FIGS. 6 to 10 illustrate examples of a cartoon content rearrangement tool according to an embodiment of the present disclosure.

FIG. 6 exemplarily illustrates a user interface provided by a cartoon content rearrangement tool installed in a plug-in form in an image edit program (e.g., a photoshop program). However, the cartoon content rearrangement tool according to an embodiment of the present disclosure may operate as a separate independent program.

Referring to FIG. 6, a cartoon content rearrangement tool 600 includes a first area 610 in which an area extraction mode is set. A first button 611 for receiving the first mode for selecting a cut area, a second button 612 for receiving the second mode for selecting a speech bubble area, a third button 613 for receiving the third mode for selecting a sound effect area, and a fourth button 614 for receiving the fourth mode for selecting a text area may be disposed in the first area 610.

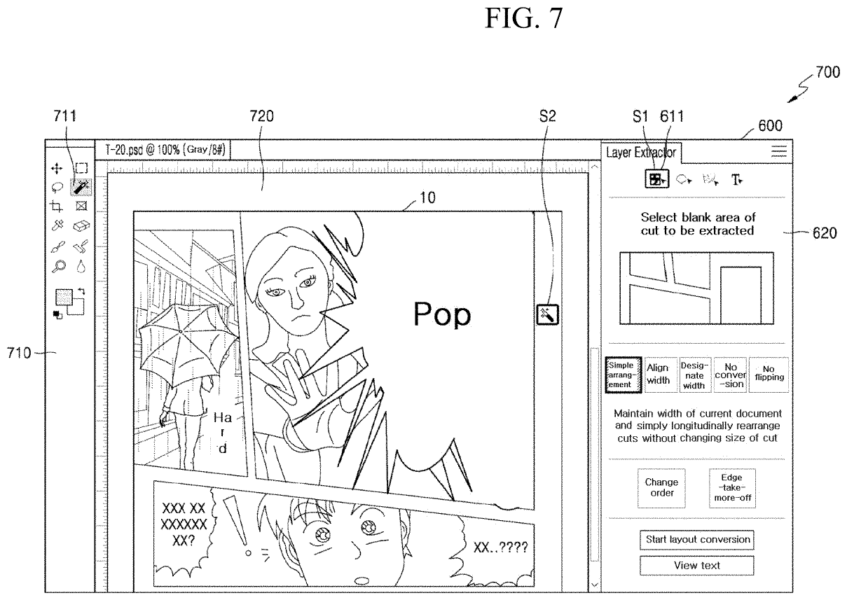

Methods of selecting areas by using the first to fourth buttons 611 to 614, respectively, are more specifically described below with reference to FIGS. 7 to 10.

The cartoon content rearrangement tool 600 includes a second area 620 in which a description related to a mode of a selected button is displayed when the first to fourth buttons 611 to 614 are selected. A description in a case where the first button 611 is selected is displayed in the second area 620 of FIG. 6. After selecting the first button 611, a user may select a blank area according to the description of the second area 620.

The cartoon content rearrangement tool 600 includes a third area 630 in which a rearrangement mode is set. A first button 631 for selecting the simple alignment mode in which the sizes of image cuts are not changed upon rearrangement, and a second button 632 for selecting the width alignment mode for constantly changing the widths of image cuts upon rearrangement may be disposed in the third area 630. Furthermore, a third button 633 for setting a document width of the second content 20, a fourth button 634 for enabling each area to be extracted only and not to be rearranged, and a fifth button 635 for reversing the left side and the right side of an image cut upon rearrangement (i.e., the left side of the image cut is flipped to the right side, and the right side of the image cut is flipped to the left side) may be disposed in the third area 630.

According to an example, any one of the first to fourth buttons 631 to 634 may be activated, and the remainder may be deactivated. As illustrated in FIG. 6, the activation of the first button 631 and the deactivation of the second to fourth buttons 632 to 634 may be default setting. The fifth button 635 may be a toggle button. FIG. 6 illustrates an example in which the fifth button 635 is activated and a mode in which the left and the right are reversed is set. When the fifth button 635 is selected again, the fifth button 635 may be deactivated, and “No flipping” may be displayed.

The cartoon content rearrangement tool 600 may include a fourth area 640 for providing options. An order change button 641 for manually adjusting an arrangement order may be disposed in the fourth area 640. A user can manually change an arrangement order of image cuts through the order change button 641. When the order change button 641 is deactivated, image cuts may be automatically rearranged.

An edge-take-more-off button 642 for setting an edge thickness (i.e., the boundary of an area) when each area is extracted may be disposed in the fourth area 640. When the edge-take-more-off button 642 is selected, areas having a thick edge may be extracted by thickly setting edge setting of the magic wand. If a speech bubble area has a thick edge, only a part of the edge may be selected by using the magic wand, so that the remaining portion of the edge may remain in a cartoon image. In this case, an area having a thick edge may be accurately extracted by using the edge-take-more-off button 642.

According to an example, the deactivation of the order change button 641 and the edge-take-more-off button 642 may be default setting.

The cartoon content rearrangement tool 600 may include a fifth area 650 for executing rearrangement. A rearrangement button 651 for cut image rearrangement may be disposed in the fifth area 650. When the rearrangement button 651 is selected, the extraction of each area, the determination of an arrangement order, and the rearrangement of image cuts may be sequentially performed. When a user selects the rearrangement button 651, an extraction instruction may be inputted to the cartoon content rearrangement tool 600.

A text hiding button 652 capable of easily displaying only a cartoon image by hiding all of a speech bubble area in which text is displayed, a sound effect area, and a text area may be disposed in the fifth area 650. A user may delete the existing text of a corresponding area and input translated text by using the text hiding button 652.

FIG. 7 is an exemplary diagram for describing a method of selecting a cut area by using the cartoon content rearrangement tool 600 according to an embodiment of the present disclosure.

Referring to FIG. 7, an example of a screen of an image edit program 700 is illustrated. The cartoon content rearrangement tool 600 is an extension tool of the image edit program 700, and is displayed on the right of the screen. The cartoon content rearrangement tool 600 has been described above with reference to FIG. 6 and is not repeatedly described.

The image edit program 700 includes a selection tool area 710 in which selection tools are disposed and a content area 720 in which the first content 10 is displayed. The selection tool area 710 may include a magic wand button 711 for selecting a magic wand.

According to an example, a user may select the first button 611 of the cartoon content rearrangement tool 600 (S1). To select, by the user, the first button 611 (S1) may include clicking on, by the user, the first button 611 by using a mouse. The image edit program 700 may receive a first mode input in accordance with the selection (S1) of the user.

The user may select a blank area of the first content 10 (S2) according to a description in the second area 620. To select, by the user, the blank area of the first content 10 (S2) may include clicking on, by the user, any one location in the blank area of the first content 10 by using a mouse. The image edit program 700 may receive a first selection input in accordance with the selection (S2) of the user.

The image edit program 700 may identify a blank area of the first content 10 by receiving the first selection input in the state in which the first button 611 has been activated, and may identify cut areas by excluding the blank area from the entire area o f the first content 10.

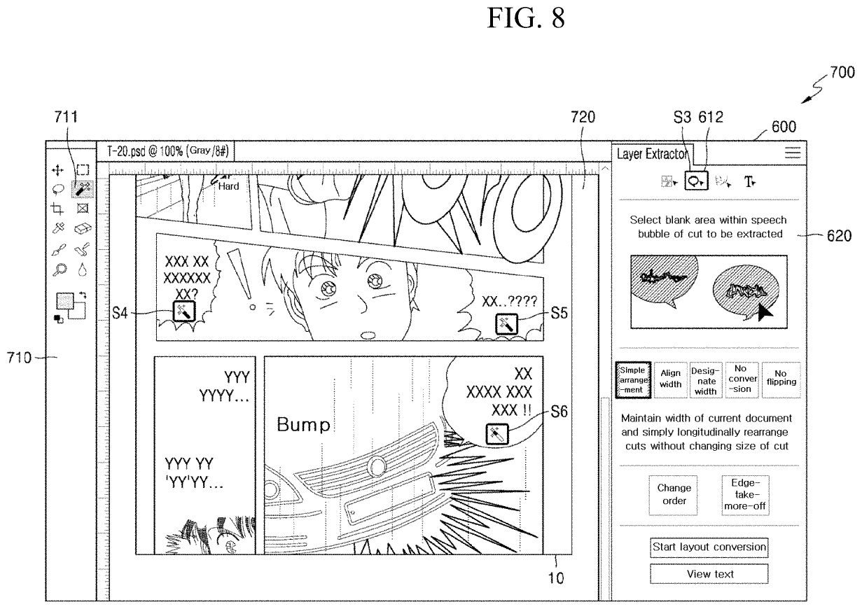

FIG. 8 is an exemplary diagram for describing a method of selecting a speech bubble area by using the cartoon content rearrangement tool 600 according to an embodiment of the present disclosure.

Referring to FIG. 8, an example of a screen of the image edit program 700 is illustrated. The image edit program 700 has been described above with reference to FIG. 7, and is not repeatedly described.

According to an example, a user may select the second button 612 of the cartoon content rearrangement tool 600 (S3). To select, by the user, the second button 612 (S3) may include clicking on, by the user, the second button 612 by using a mouse. The image edit program 700 may receive a second mode input in accordance with the selection (S3) of the user.

The user may select speech bubble areas of the first content 10 (S4, S5, and S6) according to a description in the second area 620. To select, by the user, the speech bubble areas of the first content 10 (S4, S5, and S6) may include clicking on, by the user, a location where text is not present in each of the speech bubble areas of the first content 10 by using a mouse. The image edit program 700 may receive second selection inputs in response to the selections (S4, S5, and S6) of the user.

The image edit program 700 may identify the speech bubble areas of the first content 10 by receiving the second selection inputs in the state in which the second button 602 has been activated.

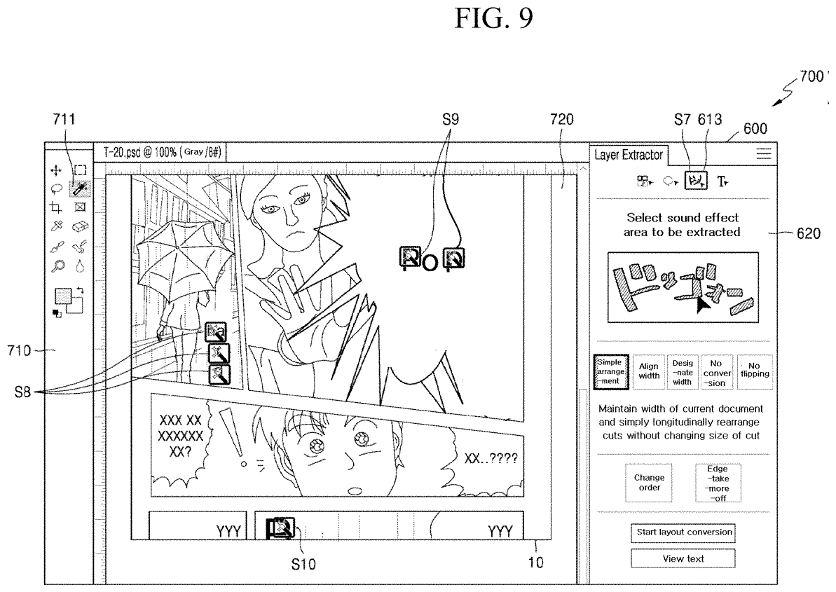

FIG. 9 is an exemplary diagram for describing a method of selecting a sound effect area by using the cartoon content rearrangement tool 600 according to an embodiment of the present disclosure.

Referring to FIG. 9, an example of a screen of the image edit program 700 is illustrated. The image edit program 700 has been described above with reference to FIG. 7, and is not repeatedly described.

According to an example, a user may select the third button 613 of the cartoon content rearrangement tool 600 (S7). To select, by the user, the third button 613 (S7) may include clicking on, by the user, the third button 613 by using a mouse. The image edit program 700 may receive a third mode input in accordance with the selection (S7) of the user.

The user may select each of sound effect areas of the first content 10 (S8, S9, and S10) according to a description in the second area 620. To select, by the user, each of the sound effect areas of the first content 10 (S8, S9, and S10) may include clicking on, by the user, the sound effect areas of the first content 10 by using a mouse. If one sound effect area is divided into two or more as in “po” and “p” in FIG. 9, as illustrated in FIG. 9, all the separated areas may be clicked on by using a mouse. The image edit program 700 may receive third selection inputs in accordance with the selections (S8, S9, and S10) of the user.

The image edit program 700 may identify the sound effect areas of the first content 10 by receiving the third selection inputs in the state in which the third button 613 has been activated.

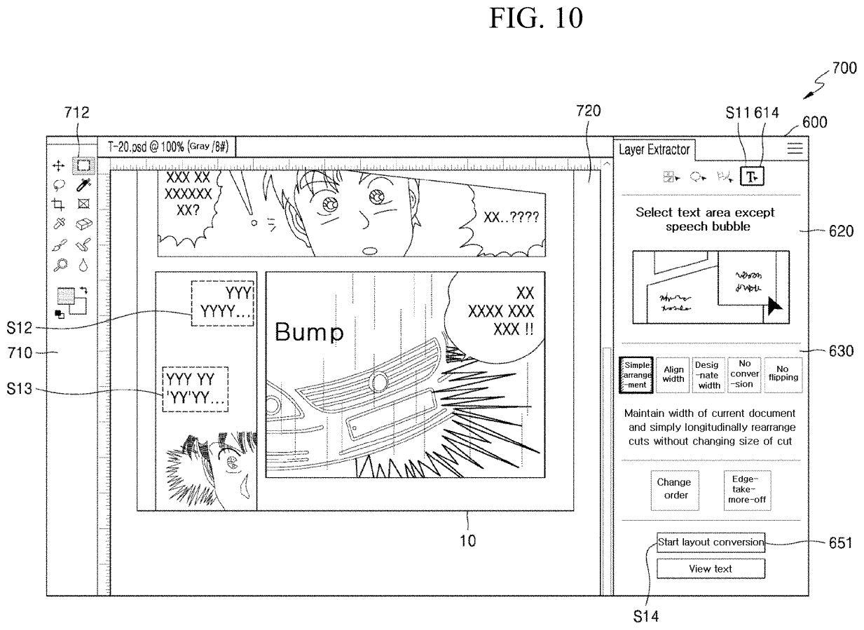

FIG. 10 is an exemplary diagram for describing a method of selecting a text area by using the cartoon content rearrangement tool 600 according to an embodiment of the present disclosure.

Referring to FIG. 10, an example of a screen of the image edit program 700 is illustrated. The image edit program 700 has been described above with reference to FIG. 7, and is not repeatedly described.

The selection tool area 710 may include a rectangle area selection button 712 for selecting a magic wand.

According to an example, a user may select the fourth button 614 of the cartoon content rearrangement tool 600 (S11). To select, by the user, the fourth button 614 (S11) may include clicking on, by the user, the fourth button 614 by using a mouse. The image edit program 700 may receive a fourth mode input in accordance with the selection (S11) of the user.

The user may select each of text areas of the first content 10 according to a description in the second area 620 (S12 and S13). To select, by the user, each of the sound effect areas of the first content 10 (S12 and S13) may include dragging, by the user, each of the text areas of the first content 10 by using a mouse so that each of the text areas is included in a rectangle selection area in the state in which the rectangle area selection button 712 has been activated. The image edit program 700 may receive the fourth selection inputs in accordance with the selections (S12 and S13) of the user.

The image edit program 700 may identify the text areas of the first content 10 by receiving the fourth selection inputs in the state in which the fourth button 614 has been activated.

The user may rearrange the image cuts of the first content 10 according to a rearrangement mode of the third area 630 by selecting the rearrangement button 651 (S14). As a result of the rearrangement of the image cuts of the first content 10, the second content 20, such as that illustrated in FIG. 3, may be generated.

In order for the cartoon content rearrangement tool 600 to identify the five cut areas, three speech bubble areas, the three sound effect areas, and the two text areas in the first content 10, a user has only to input a total of 14 selections.

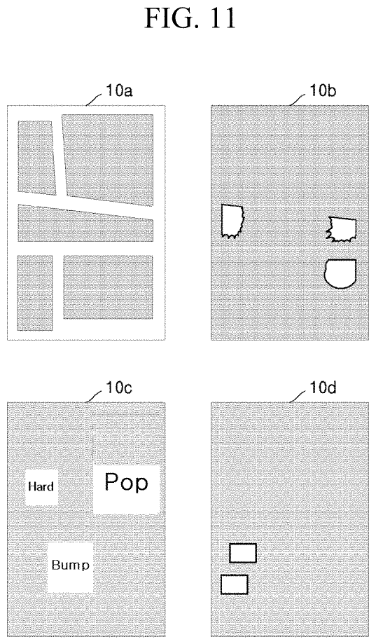

FIG. 11 exemplarily illustrates areas selected by using the cartoon content rearrangement tool 600 according to an embodiment of the present disclosure.

Referring to FIG. 11, a first channel 10a in which a blank area selected in the first content 10 is displayed, a second channel 10b in which speech bubble areas are displayed, a third channel 10c in which sound effect areas are displayed, and a fourth channel 10d in which text areas are displayed are illustrated.

In the channels 10a to 10d , the blank areas, the speech bubble areas, the sound effect areas, and the text areas are displayed in white. Cut areas may be selected by reversing the blank areas displayed in white and the areas displayed in black in the first channel 10a.

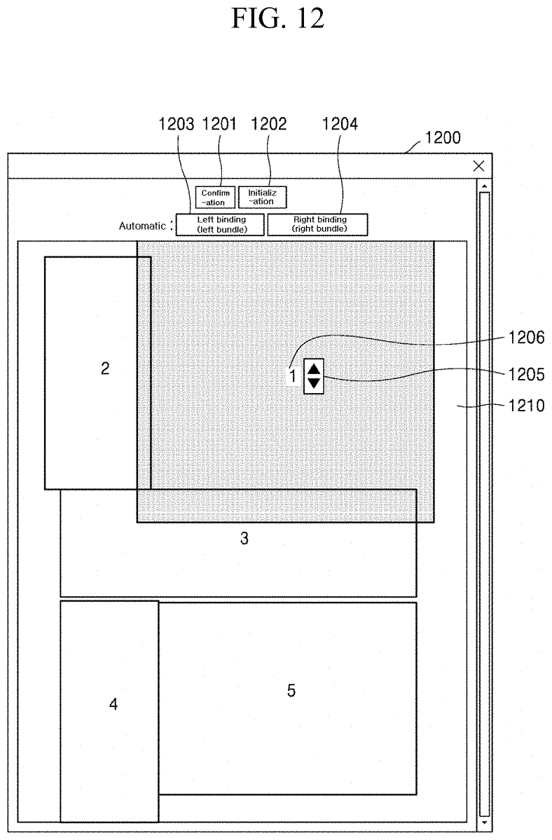

FIG. 12 exemplarily illustrates a screen in a case where a rearrangement button is selected by using the cartoon content rearrangement tool according to an embodiment of the present disclosure.

Referring to FIG. 12, after selecting each of areas as described with reference to FIGS. 7 to 10, when a user selects the rearrangement button 651 (S14), a screen 1200 may be displayed.

The screen 1200 may include a confirmation button 1201 for finalizing setting inputted through the screen 1200 and an initialization button 1202 for initializing setting inputted through the screen 1200.

The screen 1200 includes buttons 1203 and 1204 for setting a bundle mode of the first content 10 so that an arrangement order of image cuts is automatically recognized. A left binding button 1203 is a button that needs to be selected when the first content 10 is content using the left binding method. A right binding button 1204 is a button that needs to be selected when the first content 10 is content using the right binding method.

The screen 1200 includes a content display area 1210 in which divided cut areas are displayed. Only edges of cut areas may be displayed in the content display area 1210 without a cut image. A currently set arrangement order 1206 may be displayed at the center of the cut areas.

When one of the cut areas is selected, a setting button 1205 is displayed beside the arrangement order 1206. A user may adjust the arrangement order 1206 through the setting button 1205. When setting an arrangement order of all cut areas through the setting button 1205, the user may select the confirmation button 1201.

When the user selects the confirmation button 1201, the cut images of the first content 10 may be arranged in a row or a column according to the arrangement order finalized through the screen 1200.

The aforementioned various embodiments are illustrative, and should not need to be independently implemented differently from one another. The embodiments described in this specification may be implemented in a combined form.

The aforementioned various embodiments may be implemented in the form of a computer program which may be executed on a computer through various components. Such a computer program may be recorded on a computer-readable medium. In this case, the medium may continue to store a program executable by a computer or may temporarily store the program for execution or download. Furthermore, the medium may be various recording means or storage means having a form in which one or a plurality of pieces of hardware has been combined. The medium is not necessarily directly connected to a computer system, but may be distributed over a network. Examples of the medium may be magnetic media such as a hard disk, a floppy disk and a magnetic tape, optical media such as a CD-ROM and a DVD, magneto-optical media such as a floptical disk, and media configured to store program instructions, including, a ROM, a RAM, and a flash memory. Furthermore, other examples of the medium may include recording media and/or storage media managed in an app store in which apps are distributed, a site in which various other pieces of software are supplied or distributed, a server, etc .

In this specification, a “part”, a “module”, etc. may be a hardware component, such as a processor or a circuit, and/or a software component executed by a hardware component such as a processor. For example, a “part”, a “module”, etc. may be implemented by components, such as software components, object-oriented software components, class components, and task components, processes, functions, attributes, procedures, subroutines, segments of a program code, drivers, firmware, a microcode, a circuit, data, a database, data structures, tables, arrays, and variables.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

1. A method of rearranging cartoon content, comprising:
loading first content in which a plurality of image cuts is arranged in a two-dimensional manner;
extracting, from the first content, a plurality of cut areas in which the plurality of image cuts is located, respectively;
determining an arrangement order of the plurality of image cuts; and
generating second content by rearranging the plurality of cut areas in the arrangement order.

2. The method of claim 1, wherein the second content comprises the plurality of image cuts arranged in a column in the arrangement order.

3. The method of claim 1, further comprising:
receiving a first mode input for selecting a cut area;
receiving a first selection input for selecting at least one blank area in which the plurality of image cuts is not located in the first content;
receiving an extraction instruction for extracting the plurality of cut areas; and
extracting the at least one blank area based on the first selection input and extracting, from the first content, the plurality of cut areas except the at least one blank area, in response to the extraction instruction.

4. The method of claim 1, wherein the first content comprises at least one of a speech bubble containing text, a sound effect expressed in text, and text that is not contained in a speech bubble.

5. The method of claim 1, wherein:
the first content comprises a plurality of speech bubbles spaced apart from one another, and
the method further comprises:
receiving a second mode input for selecting a speech bubble area;
receiving a plurality of second selection inputs for selecting a plurality of speech bubble areas in which the plurality of speech bubbles is located, respectively, in the first content;
receiving an extraction instruction for extracting the plurality of speech bubble areas; and
extracting the plurality of speech bubble areas based on, the second selection inputs, in response to the extraction instruction.

6. The method of claim 5, wherein:
the plurality of speech bubble areas is associated with the plurality of cut areas, and
when the plurality of cut areas is rearranged, the speech bubble areas are rearranged along with the plurality of cut areas.

7. The method of claim 1, wherein:
the first content comprises a plurality of sound effects expressed in text, and
the method further comprises:
receiving a third mode input for selecting a sound effect area;
receiving a plurality of third selection inputs for selecting a plurality of sound effect areas in which the plurality of sound effects expressed in text is located, respectively, in the first content;
receiving an extraction instruction for extracting the plurality of sound effect areas; and
extracting the plurality of sound effect areas based on the third selection inputs, in response to the extraction instruction.

8. The method of claim 7, wherein:
the plurality of sound effect areas is associated with the plurality of cut areas, and
when the plurality of cut areas is rearranged, the sound effect areas are rearranged along with the plurality of cut areas.

9. The method of claim 7, wherein:
at least one of the plurality of sound effect areas is located in two cut areas among the plurality of cut areas, and
when the plurality of cut areas is rearranged, the two cut areas are integrated and rearranged along with the at least one sound effect area.

10. The method of claim 1, wherein:
the first content comprises a plurality of pieces of text that is not contained in a speech bubble spaced apart from one another, and
the method further comprises:
receiving a fourth mode input for selecting a text area;
receiving a plurality of fourth selection inputs for selecting a plurality of text areas in which the plurality of pieces of text that is not contained in a speech bubble is located, respectively, in the first content;
receiving an extraction instruction for extracting the plurality of text areas; and
extracting the plurality of text areas based on the fourth selection inputs, in response to the extraction instruction.

11. The method of claim 10, wherein:
the plurality of text areas is associated with the plurality of cut areas, and
when the plurality of cut areas is rearranged, the text areas are rearranged along with the plurality of cut areas.

12. The method of claim 1, wherein in determining the arrangement order, the arrangement order is automatically determined based on a left binding mode or a right binding mode selected based on a user's input.

13. The method of claim 1, wherein in determining the arrangement order, the arrangement order is manually determined based on a user's input.

14. The method of claim 13, wherein when the plurality of cut areas is rearranged, at least two image cuts to which the arrangement order is identically designated among the plurality of image cuts are integrated and rearranged.

15. The method of claim 1, further comprising receiving a rearrangement mode input from a user,
wherein the plurality of cut areas is rearranged based on the rearrangement mode input, and
the rearrangement mode comprises at least one of a simple alignment mode in which sizes of the plurality of image cuts are not changed and a width alignment mode in which widths of the plurality of image cuts are changed identically with a document width of the second content.

16. A non-transitory computer readable recording medium storing a computer program for executing the method for rearranging cartoon content as defined in claim 1.
